(19) United States
(12) Patent Application Publication
(10) Pub. No.: US 2026/0145480 A1
(43) Pub. Date: May 28, 2026

(54) BEARING BUSHING

(71) Applicant: Sumitomo Riko Company Limited, Aichi-ken (JP)

(72) Inventors: Valeri BECKER, Freiensteinau (DE); Artur KERBS, Hungen (DE); Christian MÜLLER, Schlüchtern (DE)

(21) Appl. No.: 19/400,202

(22) Filed: Nov. 25, 2025

(30) Foreign Application Priority Data
Nov. 27, 2024 (DE) 10 2024 135 062.8

(51) Int. Cl. B60G 21/055

(52) U.S. Cl. CPC B60G 21/0551; B60G 2204/41

(57) ABSTRACT

There is provided a bearing bushing for mounting a stabilizer bar. The bearing bushing includes a structure which surrounds the stabilizer bar. The structure includes a first structure and a second structure. The first structure 12 provides a radial rigidity for the stabilizer bar and the second structure provides a degree of torsional freedom for the stabilizer bar.

### FIELD

The present disclosure relates to a bearing bushing for a torsion bar or stabilizer bar, which is used in motor vehicles in order to stabilize motor vehicles, in particular when cornering, in accordance with the preamble of patent claim 1. Such bearing bushings typically comprise a first structure which surrounds the torsion bar or stabilizer bar in such a way that the torsion bar or stabilizer bar cannot yield in the rotational direction, wherein a second structure ensures that a distortion or torsion in the torsion bar is permitted.

### BACKGROUND

Such a torsion bar is for example known from WO 2019/025728 A1, in which a first elastomer coating is latterly injected into a holding clamp made of plastic and is to be moved into abutment with the torsion bar or stabilizer bar when being installed in a motor vehicle. A counterpiece to the holding clamp is wedge-shaped and provided with a second elastomer coating in a similar way to the first. This known bearing bushing does not permit any appreciable degree of torsional freedom.

Such bearing bushings are fixed to the body of a vehicle via a holding clamp, while the torsion bar or stabilizer bar itself is held in the radial direction, in particular rotationally rigid but in a way which hardly permits any torsional movements, within a bearing bushing which is composed of different components, thus requiring a comparatively complicated assembly.

### SUMMARY

There is provided a bearing bushing for mounting a stabilizer bar comprises a structure which surrounds the stabilizer bar in order to hold it on the vehicle, wherein the structure comprises a first structure and a second structure and wherein the first structure provides a radial rigidity for the stabilizer bar and the second structure provides a degree of torsional freedom for the stabilizer bar.

The first structure can then preferably exhibit a first inner diameter, such that the stabilizer bar rests against a first inner circumference of the first structure, and the second structure can have a second inner diameter, such that the second inner circumference surrounds the stabilizer bar over a distance. In this way, the first structure can ensure high degrees of torsional freedom, in particular when it is connected to the stabilizer bar, while the distanced second structure which is not connected, for example glued, to the stabilizer bar provides a radial rigidity.

It is also very advantageous if the bearing bushing for a torsion bar or stabilizer bar is equipped with a first structure, which surrounds the torsion bar in a soft-plastic manner, and a second structure which surrounds the torsion bar in a hard-plastic manner, wherein the material of the first structure and the material of the second structure are embodied in such a way that they form a transition layer at their connecting layers which imparts adhesive properties, for example at the molecular level.

The first and second structures can also be fixedly connected via mechanical or chemical means, for example undercuts, latching mechanisms or the like in the case of mechanical means or introduced adhesives in the case of a chemical connection. Combinations for an even better connection and even greater stability can also be advantageous.

Particularly preferably, the first and second structures are connected to each other via molecular adhesion and/or a mechanical and/or chemical connection, wherein molecules pass from the first structure to the second structure (or vice versa) along the boundary layers between the two structures, or molecular compounds or the like are produced. Such an interfacial connection, which is preferably achieved integrally during manufacture, preferably by a 2CIM injection-molding technique, is particularly stable and can be realized without additional method steps.

The bearing bushing in accordance with the present embodiments consists of two interlocking regions which can be assembled around a torsion bar or stabilizer bar. The assembled structure can then be fastened to a vehicle body via a clamp made of a hard plastic or metal.

The second structure made of a hard-plastic material, a thermoplastic or a soft-plastic material (for example TPE) can preferably already comprise the shape of a clamp, such that separate assembly is not required; instead, the two (assembled) structures already comprise the bearing bushing and the clamp. Preferred combinations of materials may include PA paired with TPU and PP paired with TPS.

The connection can be established via latching geometries or hinges, in particular film hinges in conjunction with a latching geometry, as disclosed for example in DE 10 2019 003 884 A1.

In accordance with the present disclosure, the radially acting, damping portion of the bearing bushing can be made of the same material as the torsionally acting structure of the bearing bushing. The higher radial rigidity can be realized geometrically due to a thinner rubber layer, while the structure which provides the degree of torsional freedom is equipped with a thicker rubber layer. One of the two structures in accordance with the present disclosure can therefore be connected or glued to the torsion bar, and the other part of the structure can be arranged across a gap between the plastic bearing and the torsion bar or stabilizer bar. Within this context, both material-fit connections and connections which are clamped via a frictional fit are also feasible. One structure, which is arranged in contact with the torsion bar or stabilizer bar, can therefore impart a torsional rigidity, and the other structure which is arranged across a gap with respect to the torsion bar or stabilizer bar can substantially provide the radial rigidity. One structure which is arranged across a gap on the torsion bar or stabilizer bar can therefore impart a high radial rigidity, while the gap provided enables torsion in the torsion bar, although another region of the torsion bar is connected, for example glued, to the other structure in each case.

Such a structure can particularly advantageously be manufactured inter alia by being manufactured in one piece by means of an injection-molding method, wherein such injection-molding methods are known in principle and are used for example under the designation 2CIM (two-component injection molding). A bearing bushing or torsion bar bearing in accordance with the embodiments therefore may be manufactured by providing an injection mold for the bearing bushing which is embodied to mold at least a first structure, which at least partially surrounds the torsion bar, and a second structure which at least partially surrounds the torsion bar, wherein the first structure is partially molded by injecting a thermoplastic first material into a radial inner region of the injection mold via a first injection nozzle and forming it over a first region which is at least partially circumferential. The injection mold and/or the first injection nozzle are offset parallel to a cylinder axis of the bearing bushing which is to be manufactured, and a thermoplastic second material, for example rubber, latex, etc., is injected via the first injection nozzle, adjacently to the first region which is at least partially circumferential. The thermoplastic first material is introduced into the injection mold via the first injection nozzle in a region which is at least partially circumferential and axially offset with respect to the first region which is at least partially circumferential, in order to partially mold the first structure.

Advantageously, the first structure may then be partially molded in the shape of a bracket by means of the first injection nozzle for the thermoplastic material, including the first region which is at least partially circumferential and the second region which is at least partially circumferential, i.e. at least one radially acting abutment can be produced together with the regions which provide the degree of torsional freedom, in the outer shape of a clamp comprising two partially circumferential regions which can enclose the stabilizer bar.

A soft TPE material is selected as the first material, and a hard thermoplastic is selected as the second material, wherein the first and second materials are selected in such a way that an adhesive connection is formed between these materials.

Advantageously, the first material as the hard component can, for example, be injection-molded from PA or PP, and the second material as the soft component can then for example be injection-molded from TPU or TPS.

Examples of such materials and how they are connected are known from the article “Adhesion between thermoplastic elastomers and polyamide-12 with different glass fiber fractions in two-component injection molding” by Anna-Maria M R Persson et al, Polymer Engineering and Science 2020, 60, 1642 to 1661.

It should be emphasized in relation to the present embodiments that providing a radial rigidity and a degree of torsional freedom is surprisingly enabled by using two mutually compatible materials in the form of a first and second structure, wherein unlike the prior art, a plurality of different components do not have to be assembled together or produced consecutively in order to combine radial rigidity with torsional mobility for the torsion bar or stabilizer bar.

In accordance with the present disclosure, a connection between the bearing and the holding clamp which holds the bearing along with the torsion bar on the body of a vehicle can advantageously be achieved without additional gluing and a corresponding adhesive.

In accordance with the present disclosure, a thermoplastic elastomer such as for example TPS, TPV, TPU, TPA or the like is typically used as the soft-plastic component instead of rubber or a natural rubber. A material from the following list can be used as the hard-plastic component: PP, PE, PS, PA6, PA66, PC, ABS, PC/ABS, PK, PBT, ASA or SAN, wherein these materials can additionally be fortified with glass fibers, wherein the proportion of glass fibers is preferably 0 to 50% (by mass). As previously stated, the two components mentioned must be selected in such a way, and their properties compatible, that the molecules of the soft-plastic material and the molecules of the hard-plastic material do not repel each other but rather can be connected in a transition layer, in particular adhesively, for example by so-called fusion adhesion, i.e. the materials diffuse into each other and thus form an intimate connection.

Fusion, i.e. using the 2CIM injection-molding technique, fuses the hard-plastic material and the soft-plastic material to each other at the transition layer between the two materials, wherein the molecules of the two materials are molecularly adhered by diffusing into each other.

Since all the components of the bearing bushing in accordance with the disclosure, in which the holding clamp is integrated, consist of a limited number of materials, recycling this bearing bushing along with the integrated holding clamp is easily possible without an additional effort needed to separate different materials. The integrated embodiment also eliminates the possibility of vibration or any clearance which may lead to relative movements between the surfaces and therefore also noise, as compared to the prior art. The number of processing steps can be reduced, and a bearing can in any event be prevented from sliding out of the clamp if the bearing bushing is embodied integrally with an integrated holding clamp.

The present embodiments are explained in more detail below with reference to the accompanying figures, wherein particularly preferred embodiments are described in more detail. In the figures, identical or at least functionally identical components are denoted by identical reference signs, such that it is unnecessary to repeatedly describe these components.

### DRAWING DESCRIPTIONS

FIG. 1 shows a front view of a bearing bushing in accordance with a first embodiment.

FIG. 1a shows a section A-A along the cylinder axis Z of the bearing bushing in accordance with FIG. 1.

FIG. 2 shows a front view of a second embodiment of a bearing bushing.

FIG. 2a shows the bearing bushing in accordance with FIG. 2 in a sectional view B- B in the direction of the cylinder axis Z.

FIG. 3 shows a front view of a third embodiment of a bearing bushing.

FIG. 3a shows a section A-A of the bearing bushing in accordance with FIG. 3 in the direction of the cylinder axis Z.

FIG. 4 shows an isometric view of a bearing bushing in accordance with any one of the preceding embodiments, in its position with respect to a holding clamp.

FIG. 5 schematically shows method steps for manufacturing a bearing bushing and a holding clamp.

FIG. 6 shows a front view of a bearing bushing along with a holding clamp, as manufactured in accordance with the method steps according to FIG. 5.

FIG. 6a shows a sectional view A-A of the bearing bushing comprising an integral holding clamp in accordance with the embodiment according to FIG. 6.

FIG. 7 shows an isometric view onto the embodiment in accordance with FIG. 6.

FIG. 8 shows method steps for manufacturing the embodiment in accordance with FIGS. 6 and 7.

FIG. 9 shows the performance of an embodiment with respect to its torsional rigidity under the influence of different torques.

FIG. 10 shows the radial rigidity performance under the influence of different forces in an embodiment and in consideration of the force-induced offset with respect to a bearing bushing.

### DETAILED DESCRIPTION

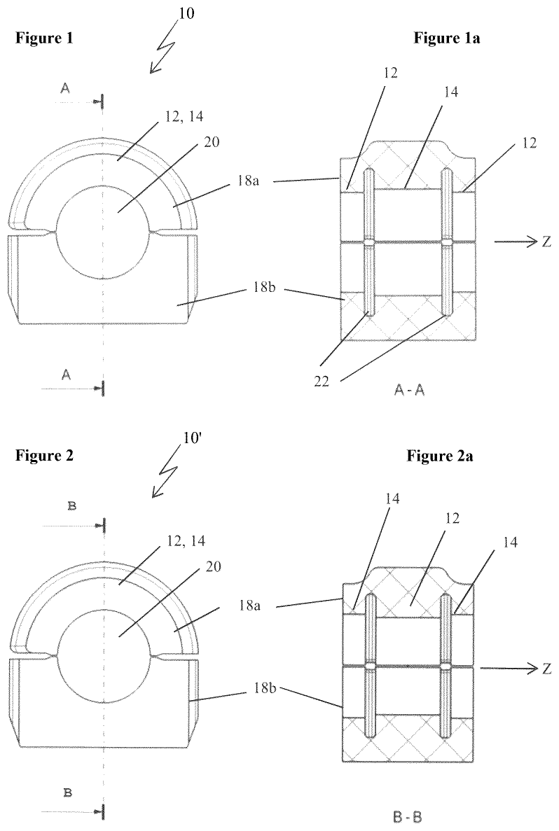

FIG. 1 shows a bearing bushing 10 in accordance with a first embodiment. Two portion parts 18a, 18b of the bearing bushing 10 extend around a stabilizer bar receptacle 20. A first structure 12 and a second structure 14 which are provided on an inner circumference of the stabilizer bar receptacle 20 provide degrees of torsional freedom but also a radial rigidity for a stabilizer bar (not shown here), i.e. the bearing bushing permits a certain degree of torsional distortion in a stabilizer bar, while substantially, i.e. almost completely, preventing the stabilizer bar from yielding in the radial direction.

Within the context of the disclosure, “radial direction” means that a stabilizer bar which is held by a bearing bushing is not capable of yielding outwards or inwards, or in particular any direction, in relation to the vehicle body, but can perform a torsional movement, i.e. a distortion.

FIG. 1a shows the first structure 12 which is radially extended inwards relative to the second structure 14, i.e. the second structure 14 has a larger inner diameter than the first structure 12, such that the stabilizer bar (not shown here) which extends in the direction of a cylinder axis Z is substantially fixed in the radial direction and virtually unyielding and provided with a high rigidity by the first structure 12, while the stabilizer bar (not shown here) can distort to a certain extent in the torsional direction, i.e. around the cylinder axis Z, as realized by the second structure 14 and therefore experiences a degree of torsional freedom.

Respective cavities 22 are provided between the two structures 12 and 14 in order to further mechanically decouple the first structure 12 and the second structure 14 from each other.

FIG. 2 shows another embodiment of a bearing bushing 10′. The different components in accordance with FIG. 2 and the different components in accordance with the section B-B in accordance with FIG. 2a, which is a section through the bearing bushing 10′in accordance with FIG. 2, are identical components, wherein the first structure 12 has a smaller inner circumference or inner radius, while the second structure 14 has a larger inner radius or inner circumference, i.e. the radial rigidity is in this case exerted on the stabilizer bar (not shown) in the inner region, while a degree of torsional freedom is permitted by the second structure 14 in the outer regions of the bearing bushing 10′.

In this case, as in all the other embodiments, the first structure 12 which imparts the radial rigidity can be connected, for example glued, to the stabilizer bar, but can also solely be mechanically press-fitted to the stabilizer bar during assembly. The regions of the second structure 14 still then permit torsional distortion in the stabilizer bar.

It may then be advantageous if the first structure 12 and the second structure 14 are made of an elastic material, preferably rubber or TPE. In this case, the second structure 14 can represent a rubber bearing. Both structures 12, 14 can however also be made of the same material, wherein the different inner diameters of the first structure 12 and the second structure 14 can provide corresponding radial rigidity properties and torsional freedom properties for the stabilizer bar. A radial rigidity can then also be realized via a thinner rubber layer in the region of the first structure 12, and a degree of torsional freedom can be realized via a thick rubber layer in the region of the second structure 14.

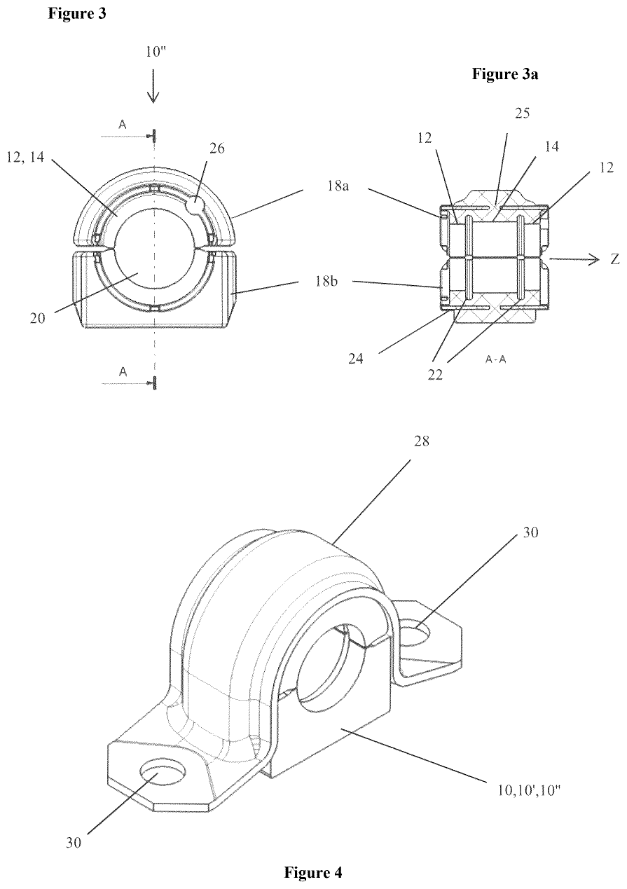

FIG. 3 shows another embodiment 10″, wherein in this case the front view in accordance with FIG. 3 additionally shows a free region 26 which serves to indicate the product and the manufacturer.

The section in accordance with FIG. 3a, which is a section through the embodiment in accordance with FIG. 3, additionally shows that an intermediate sleeve 24 is provided, in order for example to modify the radial rigidity properties or the torsional freedom properties. The intermediate sleeve 24 can be embodied to exhibit bores 25 which are for example filled with material in the 2CIM injection-molding process. The embodiment in accordance with FIGS. 3 and 3a shows how it corresponds to the embodiment in accordance with FIGS. 1 and 1a with respect to the first structure 12 and the second structure 14. This embodiment can of course also be embodied so as to correspond to the embodiment in accordance with FIGS. 2 and 2a with respect to the first structure 12 and the second structure 14.

FIG. 4 shows a holding clamp 28 made for example of metal, plastic or die-cast aluminum, which can be fastened to a vehicle frame via openings 30 by means of bolts (not shown) in order to mount a bearing bushing 10, 10′, 10′′ in accordance with any one of the previously presented embodiments.

In the embodiments in accordance with FIGS. 1 to 3a, the two portion parts 18a, 18b can preferably be connected to each other either by gluing or by press-fitting the bearing, including the clamp, on the bar. Connecting them via a hinge and a latching geometry is also feasible. Respective latching geometries on both sides are also feasible in order to connect the two portion parts 18a, 18b to each other in order to surround or enclose the stabilizer bar.

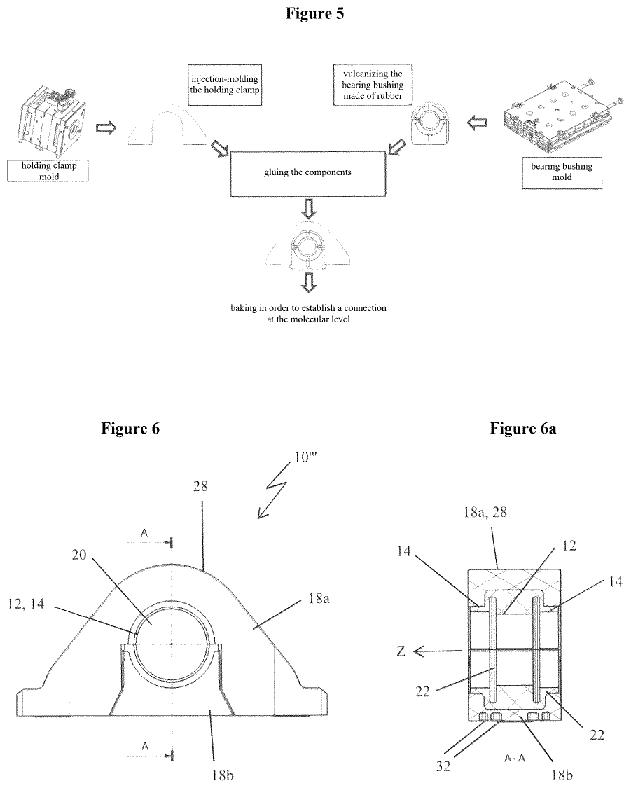

FIG. 5 schematically details the steps for manufacturing a bearing bushing 10, 10′, 10″, wherein in this case, unlike the embodiments presented above, a holding clamp made of a hard-plastic material is also manufactured, in particular by injection-molding in a holding clamp mold. The bearing bushing is manufactured from a rubber material by vulcanization in a separate bearing bushing mold. The two components (the holding clamp made of hard-plastic material and the bearing bushing made of a rubber material) are connected to each other by adding an adhesive, and the two glued components in the arrangement are connected to each other at the molecular level by being baked at a higher temperature or can also be cold-glued using other adhesives. The holding clamp can also be made of steel or die-cast aluminum and can be connected to the bearing bushing via an adhesive.

In accordance with the disclosure, the bearing bushing can be manufactured using the 2CIM injection-molding technique and then exhibits for example a configuration in accordance with FIGS. 1 to 3a.

FIG. 6 shows another preferred embodiment of a bearing bushing 10″′ comprising an integrally manufactured holding clamp 28, wherein the portion parts 18a, 18b are latched to each other in order to hold the stabilizer bar in the stabilizer bar receptacle 20. The section in accordance with FIG. 6a shows that the variant of the first structure 12 and the second structure 14 used in this embodiment is one in which the radial rigidity acts on the stabilizer bar (not shown) due to the first structure 12, while the second structure 14 provides the degree of torsional freedom. The cavities 32 show production-related free regions which have no effect on the function in accordance with the disclosure.

The first structure 12 and the second structure 14 can in turn be made of the same soft-plastically deformable material and can be partially glued to the stabilizer bar, wherein they would be glued to the first structure 12, or could also be made of different soft-plastic materials in order to impart an additional rigidity in the region of the first structure 12 which imparts radial rigidity, while a softer material could be incorporated in the region of the second structure 14 in order to improve the torsional flexibility. In this case, the cavities 22 again serve to separate the first structure 12 and the second structure 14 in order to additionally decouple the different properties of the two structures 12, 14.

FIG. 7 shows an isometric view onto the embodiment 10″′ in accordance with FIGS. 6 and 6a. The first structure 12 and the second structure 14 are separated by the cavity 22 which extends over the entire circumference. The upper portion part 18a comprises the holding clamp 28, i.e. the latter is embodied to integrally exhibit the portion part 18a. The region of the holding clamp 28 is provided with a stabilizing geometry 34 (in this case, a rib-like structure) in order to impart additional stability to the arrangement in accordance with the bearing bushing 10″′ according to this embodiment. In this case, openings 30 again are provided in order to fasten the overall arrangement consisting of the portion parts 18a, 18b to a vehicle via a bolt, screw or the like.

In this case, the two portion parts 18a, 18b can again be connected to each other via latching connections in a way which encompasses the stabilizer bar.

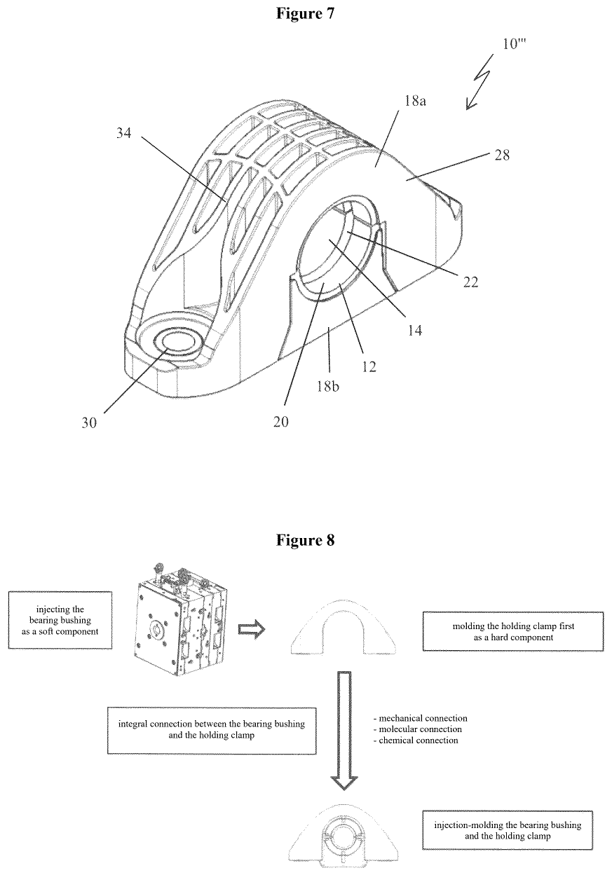

FIG. 8 schematically shows method steps for manufacturing the embodiment in accordance with FIGS. 6, 6a and 7, wherein method steps of the 2CIM injection-molding technique are used, wherein a single injection mold is used for injection-molding a bearing bushing and a holding clamp. In the injection mold shown, the hard-plastic component, i.e. the holding clamp, is formed first. The bearing bushing is then molded into the interior of the holding clamp, wherein an injection-molding technique is again used, wherein the bearing bushing can be either produced at the molecular level by selecting compatible materials which can establish a molecular connection with each other, or mechanical connections can also be introduced via undercuts or the like. In the method, an adhesive can also be introduced between the soft-plastic component and hard-plastic component in order to be able to provide a sufficiently firm connection between the hard-plastic component and the soft-plastic component.

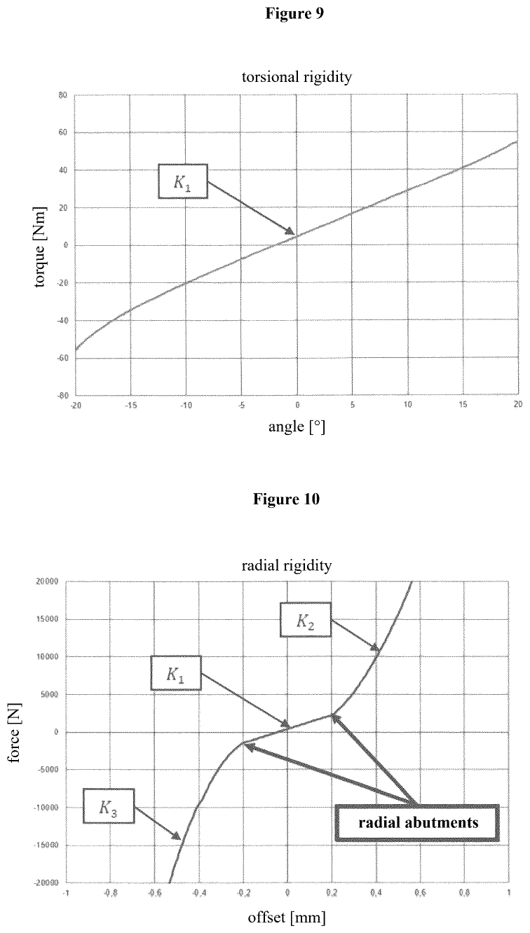

FIG. 9 presents a diagram showing the torsional rigidity which is preferably provided by a bearing bushing in accordance with the present disclosure. It shows that torsion in a stabilizer bar is enabled at appropriately low torques, thus enabling an advantageous cornering performance when steering a motor vehicle. In accordance with the diagram according to FIG. 10, on the other hand, a high radial rigidity is provided, i.e. an offset is substantially prevented, in particular by the radial abutments provided by the first structure, wherein an excellent symmetry of the radial rigidity curve around the zero point may be noted. A correspondence may be noted between the point K1 in accordance with FIG. 10 and the point K1 in FIG. 9. Other portions K2 and K3 of the curve in accordance with FIG. 10 show a significant increase in radial rigidity when the stabilizer bar is offset in the radial direction.

It has therefore been shown that the bearing bushing in accordance with the present disclosure is capable of combining an advantageous degree of torsional freedom with a high radial rigidity.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

### LIST OF REFERENCE SIGNS

10, 10′, 10″, 10″′ bearing bushing
12 first structure
14 second structure
18a, 18b portion parts
Z cylinder axis of the stabilizer bar
20 stabilizer bar receptacle
22 cavity
24 intermediate sleeve
25 bore
26 free region
28 holding clamp
30 openings
32 production-related regions
34 stabilizing geometry

1. A bearing bushing for mounting a stabilizer bar, comprising a structure which surrounds the stabilizer bar, the structure comprises a first structure and a second structure, and
wherein the first structure provides a radial rigidity for the stabilizer bar and the second structure provides a degree of torsional freedom for the stabilizer bar.

2. The bearing bushing according to claim 1, wherein
the first structure exhibits a first inner diameter, such that the stabilizer bar can be placed onto a first inner circumference of the first structure, and the second structure has a second inner diameter, such that a second inner circumference can surround the stabilizer bar over a distance.

3. The bearing bushing according to claim 1 wherein
the first structure can be connected to the stabilizer bar by at least one of a force fit, a positive fit or material fit.

4. The bearing bushing according to claim 2 wherein
the first structure can be connected to the stabilizer bar by at least one of a force fit, a positive fit or material fit.

5. The bearing bushing according to claim 1, wherein
the first structure and the second structure are made of an elastic material, in particular rubber and/or TPE, which are connected to each other by at least one of a force fit, a positive fit, or material fit.

6. The bearing bushing according to claim 2, wherein
the first structure and the second structure are made of an elastic material, in particular rubber and/or TPE, which can be connected to each other for example in a force fit and/or positive fit and/or material fit.

7. The bearing bushing according to claim 4, wherein
the first structure and the second structure are made of an elastic material, in particular rubber and/or TPE, which can be connected to each other for example in a force fit and/or positive fit and/or material fit.

8. The bearing bushing according to claim 1, further comprising
a clamp is provided by which the bearing bushing is configured to be connected to a vehicle.

9. The bearing bushing according to claim 4, further comprising
a clamp is provided by which the bearing bushing is configured to be connected to a vehicle.

10. The bearing bushing according to claim 5, further comprising
a clamp is provided by which the bearing bushing is configured to be connected to a vehicle.

11. The bearing bushing according to claim 1, wherein
the first structure provides a geometry that is configured to function as a clamp in order to connect the bearing bushing to a vehicle.

12. The bearing bushing according to claim 2, wherein
the first structure provides a geometry that is configured to function as a clamp in order to connect the bearing bushing to a vehicle.

13. The bearing bushing according to claim 5, wherein
the first structure provides a geometry that is configured to function as a clamp in order to connect the bearing bushing to a vehicle.

14. The bearing bushing according to claim 1, wherein
the bearing bushing is formed from two portion parts which are configured to surround the outer circumference of the stabilizer bar.

15. The bearing bushing according to claim 11, wherein
the bearing bushing is formed from two portion parts which are configured to surround the outer circumference of the stabilizer bar.

16. The bearing bushing according to claim 14, wherein the portion parts are divided vertically or horizontally.

17. The bearing bushing according to claim 1, wherein
the first structure is formed in the direction of the cylinder axis (Z) of the stabilizer bar at ends of the bearing bushing which surround the second structure in the direction (Z) of the bearing bushing.

18. The bearing bushing according to claim 14, wherein
the first structure is formed in the direction of the cylinder axis (Z) of the stabilizer bar at ends of the bearing bushing which surround the second structure in the direction (Z) of the bearing bushing.

19. The bearing bushing according to claim 1 wherein
the second structure is formed in the direction of the cylinder axis (Z) of the stabilizer bar at ends of the bearing bushing which surround the first structure in the direction (Z) of the bearing bushing.

20. The bearing bushing according to claim 17 wherein
the second structure is formed in the direction of the cylinder axis (Z) of the stabilizer bar at ends of the bearing bushing which surround the first structure in the direction (Z) of the bearing bushing.
